(19) United States
(12) Patent Application Publication
(10) Pub. No.: US 2026/0022031 A1
(43) Pub. Date: Jan. 22, 2026

(54) PROCESS FOR PREPARING AND USING POLYMERIC HYDROCELLS FOR PRODUCING ATMOSPHERIC WATER, USING SUPERABSORBENT POLYMERS

(71) Applicant: INSTITUTO GRANADO DE TECNOLOGIA DA POLIACRILONITRILA LTDA, Jacareí (BR)

(72) Inventor: NILTON PEREIRA ALVES GRANADO, São José dos Campos (BR)

(21) Appl. No.: 19/273,676

(22) Filed: Jul. 18, 2025

(30) Foreign Application Priority Data
Jul. 19, 2024 (BR) 10 2024 014839 8

(51) Int. Cl. C02F 1/28; B01J 20/26; C02F 1/32; C02F 1/68; C02F 1/78; C02F 9/00; C02F 101/20; C02F 101/30

(52) U.S. Cl. CPC C02F 1/285; B01J 20/264; C02F 1/32; C02F 1/68; C02F 1/78; C02F 9/00; B01J 2220/68; C02F 2101/20; C02F 2101/30; C02F 2201/009

(57) ABSTRACT

The process for producing and using polymeric Hydrocells for production of atmospheric water using a superabsorbent polymer derived from alkaline hydrolysis of the polyacrylonitrile (PAN). The Hydrocell adsorbs up to 80% of its weight in atmospheric water under ambient conditions and releases this water when heated to less than 100° C. using renewable energy sources, such as solar energy. This low-temperature operation allows for repeated adsorption and desorption cycles lasting years without degradation. Multiple Hydrocells can be arranged into Hydrobatteries with a surface area greater than 2 m², capable of adsorbing several kg of water per day. The Hydrocells offer a sustainable and safe solution for producing potable water free of toxic chemicals and pathogenic microorganisms in regions with limited water resources. By drawing water from the vast atmospheric reservoir containing over 13,000 km³, this can help prevent deaths caused by the consumption of contaminated water.

### CROSS REFERENCE TO RELATED APPLICATION

This application claims the benefit of priority from Brazilian patent application BR 10 2024 014839 8, filed Jul. 19, 2024, the contents of which is incorporate herein by reference.

### FIELD OF THE INVENTION

The present invention describes a new device for producing potable water, using polymeric cells with a high adsorption capacity for atmospheric water, herein referred to as “Hydrocells.” The “Hydrocells” have the capacity to store approximately 300 g of water per plate and can be combined in any desired array to form “Hydrobatteries” with tens or hundreds of times the storage capacity of an individual “Hydrocell.”

The “Hydrocells” are manufactured using a superabsorbent polymer, which is synthesized from the alkaline hydrolysis of the polyacrylonitrile (PAN). Plates containing layers of this superabsorbent polymer are exposed to air so they can adsorb up to 80% of their mass in water, and they are then placed in an oven where the water is thermally desorbed into vapor, condensed, and recovered in the liquid form.

Preferably, in the present invention, the oven is heated with solar energy, making the water production process completely independent of the electrical grid and sustainable, allowing it to be used in desert regions with high levels of sunlight. This high-purity atmospheric water can be used for human and animal hydration, food preparation, sanitation, and also for plant irrigation.

### BACKGROUND OF THE INVENTION

Potable water is becoming increasingly scarce for human consumption, whether due to environmental imbalances leading to lack of rainfall, contamination of freshwater by domestic and industrial sewage, the need for irrigation, or the depletion of groundwater sources. According to the March 2023 UN conference, approximately ¼ of the world's population lacks access to potable water, and 10% of the world's population lives in regions experiencing high and critical water stress.

Given this alarming scenario, where 800 million people live in water-stressed regions, it is necessary to develop new technologies for producing potable water. In addition to the conventional river and reservoir water treatment processes that employ filtration systems and flocculation agents, the desalination by reverse osmosis or distillation has played a significant role in supplying water to desert countries, such as those in the Middle East, especially Israel, Saudi Arabia, and the United Arab Emirates, which lack water sources other than seawater. However, the energy costs of desalination processes have a significant environmental impact, both due to the emission of CO: into the atmosphere from the burning of fossil fuels to generate the energy required for the process and the release of enormous amounts of brine formed during the process into the sea, affecting marine life in coastal regions.

Given the need to supply water to more than 800 million people living in desert and semiarid regions, which have only scarce water resources, water production methods that utilize the atmospheric reservoir have been studied. This reservoir is immense, measuring 12,900 km³, and is responsible for the formation of all the Earth's rainfall, supplying water to all its rivers, lakes, and glaciers, and its exploitation is sustainable and practically inexhaustible anywhere on the globe, as the air contains 2 g to 25 g of water per m³ in the form of vapor.

Three technologies are currently known that offer possibilities for producing atmospheric water, but all have limitations:
A) Air cooling—This process uses refrigeration systems that reduce the air temperature to its dew point, allowing the water vapor to condense. Systems equipped with compressors with refrigerant fluids or Peltier effect cooling plates can be used, but both require high energy consumption. Chemical water treatment methods are more efficient and consume a small fraction of the energy required to operate an atmospheric water generator by cooling, making them uneconomical in locations where water is available for treatment. The need for air relative humidity above 50% makes these equipment uneconomical in desert locations with lower humidity levels, such as the Australian desert, the Sahara, the Atacama region, and the west coast of the USA. Dozens of these types of apparatus are available on the market, and the water production can range from a few liters per day to hundreds, depending on the equipment's power. Consumption can range from 0.5 to 7 kWh/L, varying depending on humidity and air temperature conditions. An excellent study of this equipment can be found in the following paper by Roland V. Wahkgren, titled “Atmospheric Water Processor Designs for Potable Water Production: A Review,” published in Wat. Res. Vol. 35, No. 1, pp. 1-22, 2001.
B) Fog Capture Nets—This process relies on the condensation of fog water on the surfaces of nets or screens and, therefore, can only be used in desert regions that experience fog at night or in the morning, such as the coast of Peru and Chile, Namibia, and some regions of Morocco. This process consumes no energy, and water productivity is low. The Creating Water Foundation implemented a fog net project in Lima, Peru, that produces 10,000 liters per day with 60 nets. In nature, animals and plants in foggy areas use this air humidity to hydrate themselves. The best-known example is the beetle in Namibia, which has nanostructures on its wings that condense water in hydrophilic regions and direct it through hydrophobic channels to its mouth for ingestion.
C) Use of Hygroscopic Substances—In this method, the atmospheric water is absorbed or adsorbed onto hygroscopic substances, to be released as vapor through heating and condensed into the liquid form. Among the substances that can be used are inorganic salts such as lithium chloride, lithium bromide, calcium chloride, zinc chloride, magnesium chloride, minerals such as zeolites, silica, glycols, and sulfuric acid, and recently, metal-organic frameworks (MOFs), such as zirconium-based 801 and aluminum-based 303 MOFs, which adsorb 40% to 50% of their weight in atmospheric water under relative humidity conditions of 30% to 50%. The main problem with using substances that act through an “absorption” process is that the water can become chemically bound, such as water of crystallization in the crystalline structure, such as lithium chloride, zinc chloride, and calcium chloride, and to be released, temperatures above 300° C. are required, resulting in significant energy consumption. Another drawback to using these substances is that they become liquid during the process, as they can dissolve in the water absorbed from the air (deliquescence), thus reducing the absorption area. This makes it difficult to build rigid structures with a high surface area for the absorption and recovery of substances in the cycles involved in the process. Therefore, for use in the atmospheric water capture, it is more advantageous to use substances that act through an adsorption process, as the water is more weakly bound to the surface of the substance and can be released at temperatures below its boiling point, which is 100° C. The substances that adsorb water can also remain solid during the adsorption process, as it is often a superficial phenomenon, which facilitates the subsequent thermal desorption, allowing for a large number of cycles. Among the substances that capture atmospheric water through adsorption processes are zeolites, some MOFs, silica gel, and superabsorbent polymers, such as the alkaline salts of the hydrolyzed polyacrylonitrile, the object of this invention.

During research with the polyacrylonitrile for the production of superabsorbent polymers for agricultural use, it was observed that, under certain alkaline hydrolysis conditions, with potassium hydroxide or sodium hydroxide, some salts rapidly absorbed humidity from the air, reaching 80% of their weight in water, higher than that of the MOFs studied and patented by the University of Berkeley and the Massachusetts Institute of Technology (MIT), both in the USA.

By transforming these superabsorbent polymers into plates, it was possible to produce a stable, rectangular structured configuration with excellent mechanical and thermal properties, for the purpose of this invention, which are called herein “Hydrocells” and their combinations in larger arrangements, which are called “Hydrobatteries.”

The “Hydrocells” are manufactured using layers of the salts of the cross-linked superabsorbent polymer poly(acrylate-co-acrylamide) synthesized from the alkaline hydrolysis of the polyacrylonitrile, distributed over a fabric (therefore, a composite material), which provides mechanical strength to the plates. By combining dozens or hundreds of these “Hydrocells,” it is possible to assemble “Hydrobatteries” with a large atmospheric water storage capacity, even in desert regions with humidity levels as low as 30%.

Since the desorption process of the water stored in the “Hydrocells” is carried out inside an oven up to 100° C., the process becomes completely sustainable when using solar energy, in thermal or photovoltaic form, operating entirely without connection to the electrical grid, ideal for remote and desert areas of the planet, where there is a scarcity of potable water and high solar radiation.

The completely dry “Hydrocells” are again exposed to air to adsorb water, and the adsorption-desorption cycle can be repeated hundreds or thousands of times with minimal polymer degradation, making this process quite advantageous compared to other methods that produce atmospheric water by cooling the air to its dew point, which consume a lot of energy, in the range of 0.5 to 5.0 kWh per liter of water and, depending on the atmospheric humidity conditions, if the humidity is low, they can consume more than 7 kWh/L. The Hydrocell preferably has a rectangular or circular shape, with screens in its area exposed to the air and, in the middle, a flexible fabric to provide better mechanical strength.

Another feature of this patent that differs from all others on the subject is that the use of “Hydrocells” for water storage allows for a wide variety of possible arrangements in “Hydrobatteries,” which can be used exclusively to accumulate water for days or weeks, generating the desired amount at the appropriate time. Hydrocells are placed on a clothesline-shaped structure containing several units, in an arrangement with a surface area greater than 2 m².

The water adsorption process in the “Hydrocells” is passive, requiring only exposure to air; however, the use of ventilation can accelerate the same, especially at night, when atmospheric humidity is generally higher. Therefore, the best way to operate “Hydrobatteries” is to accumulate water at night and produce water during the day, using solar energy to generate heat.

The present invention can be applied to water production in any location on our planet without grid power. There is particularly highlighted its great potential for producing potable water in populated areas where the atmospheric phenomenon of “desert fog” occurs, when atmospheric humidity reaches over 70%.

Under these conditions, the “Hydrobatteries” become even more efficient, being able to passively accumulate up to 80% of their weight in water in a single nighttime period. Among the populated regions of the planet where “desert fog” occurs, making this invention a sustainable water production option, there is highlighted the Lima region in Peru, which has a rainfall rate of 6 mm per year and a population of approximately 11 million people. It is one of the largest cities in the world located in a desert.

Other regions with the same atmospheric conditions are the Atacama Desert in Chile, the Baja California Desert, the Namibian Desert, the coastal region of the Arabian Peninsula, and the Anti-Atlas Mountains region in southwestern Morocco.

### STATE OF THE ART

As mentioned previously, there are three techniques used to produce atmospheric water: A) By air cooling; B) By using fog nets; C) By using hygroscopic substances. Since methods A) and B) are completely different from the scope of the present invention, the focus will only be on the state of the art of item C), which has similarities with this invention but does not utilize the new superabsorbent polymer obtained by alkaline hydrolysis of the polyacrylonitrile (BR 10 2020 006578-5 and US20230108608), of this inventor. The process presented herein with this new superabsorbent polymer offers numerous advantages over the competing substances.

This patent application US20230108608 describes the hydrolysis process used to produce superabsorbent polymer (SAP) based on cross-linked poly(acrylate-co-acrylamide), in the form of sodium and potassium salts, which, while having a high degree of swelling with water, in the order of 150 to 800 g of water/g of polymer, have high hygroscopicity, being able to accumulate up to 80% of their weight in atmospheric water. Combined with this property of swelling in the presence of liquid water and adsorbing atmospheric water, this polymer has excellent mechanical properties to be transformed into plates, which, whether wet or dry, have little variation in their dimensions, when the superabsorbent polymer is applied to a resistant fabric, forming a composite material.

One of the first patents mentioning the use of hygroscopic substances to harvest water from the air is patent U.S. Pat. No. 2,138,689 from 1934, which used wood as an absorber of air humidity. This invention describes a piece of equipment that allows pieces of wood to be moistened at night and releasing water during the day by solar heating. Wood is a very poor hygroscopic material and only absorbs in greater quantities in high air relative humidity. The yield of the harvested water is also low, as regions with high air humidity are always rainy, and without solar heating, and there is no water production.

Another patent, U.S. Pat. No. 3,777,456, describes a process that uses lithium chloride solution, but it can be used with other hygroscopic liquids. In this case, air is passed through the hygroscopic liquid in the form of a film, allowing it to absorb humidity from the air, causing its dilution. Additional water is removed by distillation, and the brine at its initial concentration is returned to the process.

U.S. Pat. No. 4,146,372 describes an atmospheric water extraction process using silica gel spheres with 16% and 24% SiO₂ content and pore diameters between approximately 40 and 60 Angstroms. Thus, moist night air is passed through a bed containing 8-mm to 12-mm silica gel spheres, which perform surface adsorption on the air, acting as a desiccant. During the day, the air is heated to between 25° C. and 70° C. and passed through the silica gel bed, which absorbed moisture overnight. The desorbed water is then condensed on a cold stone surface and harvested. The suggested energy source for heating the air can be solar or recovered from thermal power generation facilities. The patent also describes the method for obtaining the silica gel to be used in the equipment.

Another patent, U.S. Pat. No. 4,726,817, describes equipment for producing atmospheric water using hygroscopic fibers. In this case, air containing water vapor is conveyed through radiant heat exchangers. The cooled air passes through the hygroscopic fibers and condenses as liquid water. The patent does not mention the types of hygroscopic fibers or the water production yield.

Patent WO 2011 120054 describes a desiccant material for removing humidity from the air, based on calcium chloride impregnated in a porous substrate made of PVA foam or a nonwoven rayon fibrous sheet. The desiccant is maintained in the 50 to 1000 micron pores of the substrate. The sheets can be arranged in multilayer arrangements to allow air to pass through and increase the water absorption efficiency. The patent does not describe the temperature conditions for regenerating the desiccant material, nor the use of the released water. Currently, there is only one commercially available device that uses hygroscopic substances to produce atmospheric water, wherein the first prototypes were patented by Zero Mass Water Inc. under the name “Source Hydropanels” and described in patents U.S. Pat. Nos. 10,357,739, 10,632,416 and patent applications US20200332498, US20200283997, and US20180043295. These patents essentially define the device that uses porous desiccants, the operating conditions, and the use of solar-powered thermal desorption. These devices produce 2 to 5 liters of atmospheric water per day using solar energy at a cost of US$3,500 per device. These patents and patent applications do not specify which porous desiccants are used.

On the other hand, patents U.S. Pat. Nos. 11,059,838 and 10,683,644 describe an atmospheric water harvester system employing a new class of substances known as metal-organic frameworks (MOFs) derived from aluminum (MOF-303) and zirconium (MOF-801). These MOFs have the property of adsorbing up to 40% to 50% of their weight in water, even under conditions of low atmospheric humidity, and the desorption process can be carried out at temperatures below 100° C.

U.S. Pat. No. 11,014,068 describes the synthesis of one of these MOFs used in these cited patents, specifically, aluminum 1-H-Pyrazole-3,5-dicarboxylate (MOF-303), which is a hygroscopic, porous substance with a high surface area (1380 m²·g⁻¹) and therefore suitable for use in the adsorption of atmospheric water. This MOF-303 has a maximum adsorption capacity of up to 48% of its weight in water, and at 20% air relative humidity it was able to adsorb 28% of its weight in water. This patent also discloses that MOF-303 was subjected to 150 cycles of adsorption and desorption at 85° C. without losing its ability to store water.

As can be seen previously, the devices or systems used to produce atmospheric water through adsorption or absorption processes always employ hygroscopic substances such as salts, lithium chloride lithium (LiCl), bromide (LiBr), calcium chloride (CaCl₂), magnesium chloride (MgCl₂), oxides such as silica (SiO₂) and phosphorus pentoxide (P₂O₅), acids such as sulfuric acid (H₂SO₄), and organic substances such as glycols, ethylene glycol, glycerol, and MOFs. There are no documents in the state of the art that report the use of salts of the hydrolyzed polyacrylonitrile as atmospheric water adsorbers, much less the process of their recovery in equipment for daily water production.

The great advantage of using the salts of the hydrolyzed polyacrylonitrile in relation to the use of the other substances mentioned above is their ability to be formed into hygroscopic films and plates, where the water adsorbed on their surface moves in a diffusional way to the core of the plate, until reaching its saturation limit, which can be 80% of their weight in water, remaining solid during the water adsorption and desorption cycles. Alkaline salts of the hydrolyzed polyacrylonitrile and their copolymers have a cross-linked polymer chain, a swelling degree of 150 g to 800 g of water per gram of the polymer and adsorption capacity of atmospheric water up to 85% of their weight.

The plates, herein referred to as “Hydrocells,” composed of the alkaline salts of the hydrolyzed polyacrylonitrile, possess excellent mechanical properties for the proposed purpose of this invention. Inorganic salts lack these properties because they become liquid after absorbing water. This significantly complicates the process, as their surface area is drastically reduced, reducing efficiency.

The strong bond between the hydration water and these salts requires high temperatures, on the order of 250° C. or more, to regenerate the same. Among the substances that remain solid during the water adsorption process is silica, but it has the disadvantage of adsorbing only 20% of its weight in water and cannot be formed into plates or composite materials without altering this property.

In turn, the recently discovered MOFs, despite having a large surface area, cannot be formed into plates or films by compaction or form a composite material without losing surface area. They are always used in powder form, contained in a container in the described equipment, which makes it difficult to build robust, compact equipment for large-scale water production. Another disadvantage of the MOFs is that the precursor substance used in their synthesis, 3,5-pyrazoledicarboxylic acid, is not industrially produced and its current price is in the order of tens of dollars per gram, making atmospheric water generation equipment with several kg of MOF-303 exorbitantly expensive. In the same comparison, a sodium or potassium salt of the hydrolyzed polyacrylonitrile costs around US $5/kg.

Another important concept presented in this invention is that of “Hydrobatteries,” which are devices capable of storing large quantities of atmospheric water above ground, functioning analogously to a water tank, where water can be harvested in the desired quantity and at the desired time.

A “Hydrobattery” may be sized to be placed directly in the thermal desorption oven and have an adequate number of “Hydrocells” for a minimum water production per 8-hour or 10-hour solar cycle. When not in use, the “Hydrobatteries” accumulate atmospheric water passively or more rapidly under ventilation.

The present invention presents, as an example, a “Hydrobattery” containing 25 “Hydrocells,” which can be seen in FIG. 2.

In turn, the device referred to herein as a “Hydrocell” is an individual “Hydrobattery” unit composed of 400 g of the sodium, lithium, or potassium salt of the cross-linked hydrolyzed polyacrylonitrile, distributed on a rectangular fabric surface, preferably cellulose-based, which has the capacity to adsorb 200 to 320 g of atmospheric water until saturation.

This material, composed of superabsorbent polymer and fabric, is flexible, does not tear easily, and is placed inside a 250 mm×310 mm metal structure with a 10 mm thickness of stainless steel or aluminum, with mesh on both sides to provide greater mechanical strength to the structure, as can be seen in FIG. 1.

The great innovation of the present invention, not only conceptually due to the use of “Hydrocells” and “Hydrobatteries” (which have never been mentioned in any patent researched), is the use of this polymer for this application of atmospheric water capture, which presents properties unavailable in any type of superabsorbent polymer on the market, such as those based on sodium and potassium polyacrylate.

The following relevant properties can be highlighted in the alkaline salts of the cross-linked hydrolyzed polyacrylonitrile:
a) high atmospheric water adsorption capacity starting at 30% air relative humidity, with a saturation limit of approximately 80% of the polymer's weight in adsorbed water.
b) desorption temperature below the boiling point of water, starting at 55° C. and with an ideal point at 80° C.
c) high thermal stability, without loss of water adsorption properties, even when operating at 180° C. This property is of particular interest because the lower the desorption temperature is in relation to its thermal degradation temperature, which is 210° C., the longer the useful life of the “Hydrocells.” To date, there are “Hydrobatteries” with “Hydrocells” operating over 600 8-hour desorption cycles at 80° C. without loss of their properties. By rotating a set of 7 “Hydrobatteries,” with one of them used each day of the week, there will be 6 days of water accumulation and 1 day of production. There can be estimated that the useful life of a “Hydrobattery” is over 10 years.
d) plastic capacity, capable of being formed into mechanically resistant plates with little dimensional variation when wet or dry.
e) because it is a superabsorbent polymer obtained from another polymer, polyacrylonitrile, it does not release into the produced water acrylic acid residues and toxic substances present in commercial superabsorbent polymers based on polyacrylates, obtained with the acrylic acid monomer.
f) low environmental impact when the “Hydrocells” are disposed of in the environment at the end of their useful life. The superabsorbent polymer residues, such as the potassium salt of the hydrolyzed polyacrylonitrile, are biodegradable in soil and do not inhibit the degradation of other substances, as determined by a biodegradability study conducted at the São Paulo State Institute of Technological Research (IPT). According to the “OECD” Guideline for Testing of Chemicals (item 301B, 1992), the biodegradation of this polymer is 36.0%+/−13.8% in 28 days.
g) use of renewable solar energy to perform thermal desorption of water stored in the “Hydrocell”.

Since the water desorption temperature starts at 55° C. and the operating temperature is 80° C., energy can be obtained using electrical energy produced by photovoltaic panels to heat the oven's heating elements or by direct solar radiation focused inside or on the oven walls.

In this way, a “Hydrobattery” containing 25 “Hydrocells” with 400 g of polymer can release approximately 7 liters of water when heated to 80° C. for 5 hours, using four 580 W photovoltaic panels. Heating the Hydrobattery for water desorption consumes between 0.6 and 2 kWh. The energy consumption for carrying out the thermal desorption process at 80° C. in the polymer is equivalent to the energy consumption for producing 1 L of distilled water, approximately 0.7 kWh/L. However, in practice, this number is slightly higher, around 1 kWh/L, due to the presence of the polymer mass, which also absorbs heat.

### SUMMARY OF THE INVENTION

To better understand this invention, the following definitions are presented:

Polyacrylonitrile (PAN): is a vinyl polymer with the formula (C₃H₃N)ₙ obtained by polymerizing the acrylonitrile (AN) monomer with the formula C₃H₃N, which is widely used in the production of acrylic fibers and carbon fiber.

Hydrolyzed polyacrylonitrile (HPAN) is the substance obtained by subjecting the polyacrylonitrile to a hydrolysis reaction with bases such as sodium, potassium, and lithium hydroxides and their carbonates. In this reaction, the polyacrylonitrile is transformed into mixed copolymer salts of cross-linked polyacrylate and polyacrylamide.

A “Hydrocell” is a plate containing a certain amount of salt of the hydrolyzed polyacrylonitrile distributed over the surface of a fabric, subsequently attached to a metal support with a screen. This “Hydrocell” has the capacity to adsorb up to 80% of its weight in atmospheric water, either passively or with ventilation. The water in the “Hydrocell” is released upon heating, and the same “Hydrocell” can be reused for hundreds and thousands of cycles of water adsorption and desorption.

A “Hydrobattery” is an arrangement of dozens of “Hydrocells” that has the capacity to store several kg of water. Its shape must be suitable for allowing the adsorption of atmospheric water either passively or through ventilation, while at the same time being easily introduced into the oven for thermal desorption at the lowest possible temperature.

The process for preparing Hydrocells and their use in the production of atmospheric water, using superabsorbent polymers, has the following steps:
1) Hydrolyzing the Polyacrylonitrile and obtain its salts;
2) Drying the salts;
3) Grinding the salts;
4) Manufacturing the “Hydrocell”;
5) Arranging “Hydrocells” to produce a “Hydrobattery” module;
6) Allowing the “Hydrobattery” to adsorb atmospheric water;
7) Placing the “Hydrobattery” in the oven to desorb the water;
8) Harvesting, filtering, and mineralizing the obtained atmospheric water;
9) Allowing the “Hydrobattery” exposed to air again to repeat the water adsorption cycle, and so on.

### BRIEF DESCRIPTION OF THE FIGURES

To obtain a complete and comprehensive understanding of the purpose of this invention, the figures to which reference is made are presented, as follows.

FIG. 1 presents a “Hydrocell” with its dimensions.

FIG. 2 presents a “Hydrobattery” with its dimensions and containing 25 “Hydrocells”.

FIG. 3 presents a “Hydrobattery” in its ventilation carriage.

FIG. 4 presents the thermal desorption oven for the water in the “Hydrobattery” and its dimensions.

FIG. 5 presents the thermal desorption oven with the “Hydrobattery” in the position in which it is inserted therein.

FIG. 6 presents the thermal desorption oven with the “Hydrobattery” already inserted therein.

### DETAILED DESCRIPTION OF THE INVENTION

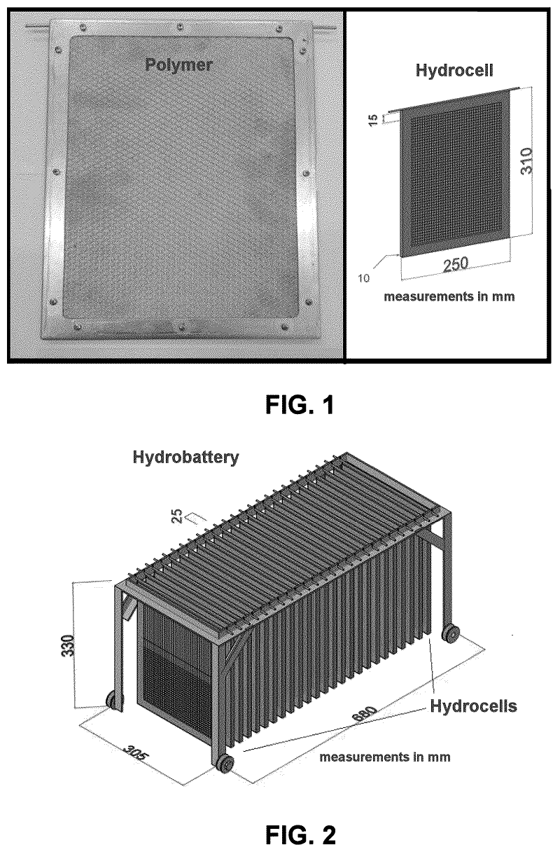

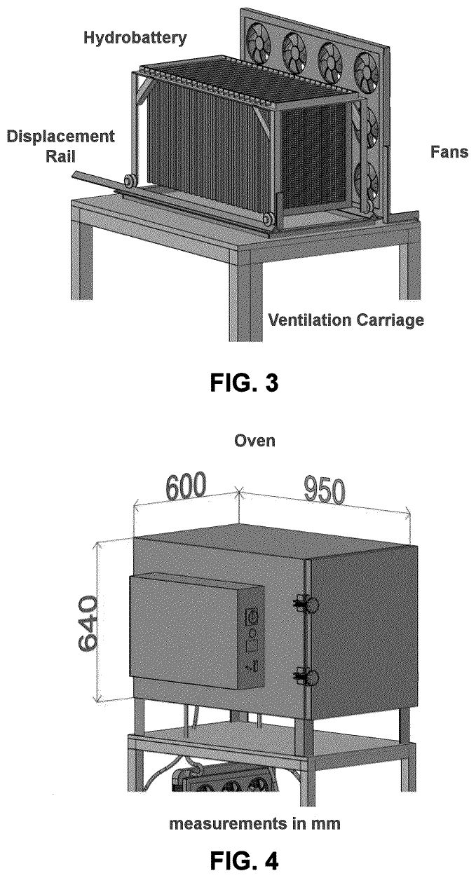

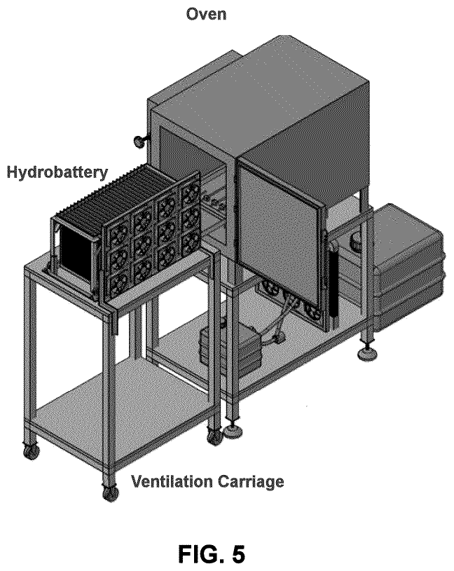

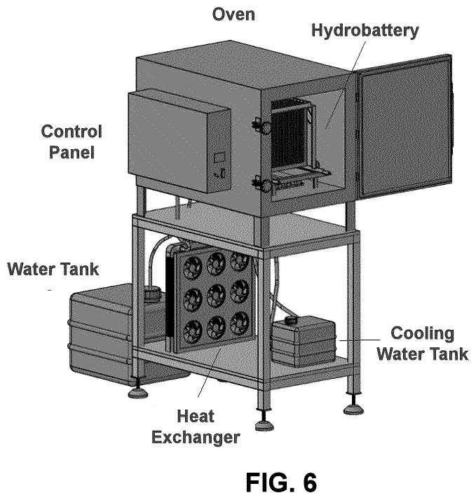

The present invention relates to the process of producing and using Hydrocells for atmospheric water production using superabsorbent polymers, which comprises the following steps:
1) Hydrolyzing the polyacrylonitrile and obtaining its salts. This process is described in detail in patent application US20230108608 and basically consists of mixing the polyacrylonitrile of a specific chemical composition and molecular weight with potassium, lithium, and sodium hydroxide solutions. The mixture is transferred to an autoclave, which operates at a rate of 1 kgf/cm² to 5 kgf/cm² and is heated at 100° C. to 140° C. for a hydrolysis time of 3 to 5 hours. The degree of hydrolysis is controlled by the amount of ammonia released during the process and should be between 40% and 60%. In this way, there is produced a superabsorbent polymer consisting of cross-linked poly(acrylate-co-acrylamide) with a swelling degree in liquid water of 150 to 800 g of H₂O/gram of the polymer and which can adsorb from air up to 0.5 to 0.8 g of H₂O/gram of polymer.
2) Drying the salts. The hydrolyzed polyacrylonitrile thus obtained, in the form of an alkaline salt, leaves the autoclave containing 30% to 40% moisture in massive plates weighing 5 kg to 10 kg. These plates are cut into 20 mm to 100 mm strips in a shredder to facilitate drying. They are then fed to a conveyor oven operating between 120° C. and 150° C. After drying to 5% to 8% moisture, they can be subjected to the grinding process.
3) Grinding the salts. For the alkaline salts of the hydrolyzed polyacrylonitrile to be spread on a fabric surface to produce a “Hydrocell,” they must be ground to a particle size smaller than 200 mesh or 0.074 mm. This process is performed in a rotary knife mill at 1,000 to 1,500 rpm and equipped with a vibrating sieve with a classifying screen to separate particles smaller than 200 mesh. Immediately below the classifying sieve, the ground polymer is immediately placed into plastic bags for storage and to avoid atmospheric humidity.
4) Manufacturing the “Hydrocell”. The “Hydrocell” is assembled in two steps. First, a specific amount of powder of the hydrolyzed polyacrylonitrile salt is spread in a rectangular mold 10 to 15 mm deep. The powder is allowed to agglomerate by atmospheric water adsorption for 12 to 24 hours. After this period, a layer of cellulose mesh is applied to improve puncture and tear resistance. The same amount of hydrolyzed polyacrylonitrile salt is then applied to the mesh and allowed to absorb humidity from the air again for 12 or 24 hours. After this period, the plate can be demolded and placed inside the stainless steel or aluminum metal structure (FIG. 1). It is also convenient to protect the surface of the plate with a metal mesh, preferably expanded aluminum. The metal structure also has the same dimensions as the plates, and they are fixed inside the structure with screws or rivets. It should also have a 3 mm diameter stainless steel wire rod running across its width, so that it can be suspended in the “Hydrobattery” module. “Hydrocells” produced in this way can adsorb up to 80% of atmospheric water. Under atmospheric humidity conditions between 60% and 80%, between 20° C. and 30° C., a “Hydrocell” containing 400 g of the potassium salt of the hydrolyzed polyacrylonitrile can adsorb 320 g of water in 24 hours using 3 m/s ventilation. With relative humidity between 30% and 50% between 20° C. and 30° C., this time can increase from 48 to 72 h to reach the saturation level of the plates.
5) Arranging the “Hydrocells” to produce a “Hydrobattery” module. The “Hydrobattery” module can contain as many “Hydrocells” as desired (FIG. 2). Since the phenomenon of adsorption and desorption is related to surface area, while a single “Hydrocell” measuring 26 cm×21 cm has an area of 0.1 m², the “Hydrobattery” must have at least 2.5 m² of plates to ensure an adequate water production. In this case, the “Hydrobattery” consists of an aluminum or stainless steel structure in a rectangular box shape, allowing the suspended “Hydrocells” to be placed 2 to 3 cm apart. This distance allows air to circulate both for water adsorption and for the circulation of hot air from the oven to desorb water from the plates. The “Hydrobattery” volume should be 60% to 70% of the oven volume (FIG. 4) for good air circulation. Thus, the “Hydrobatteries” are placed inside the ovens to undergo a thermal desorption cycle for a period of 4 to 8 hours, until completely dry. After that, they can be removed and returned to a ventilated location to again adsorb water from the air. This location may also contain a large number of other “Hydrobatteries” in different stages of collecting water from the atmospheric air, so that, in the solar cycle of the following day, another one saturated with water can be used in place of the one that came out. This will allow for a constant daily production of potable water. If a “Hydrocell” containing 400 g of polymer can adsorb 80% water or 320 g of water to its saturation point, then a “Hydrobattery” with 100 “Hydrocells” can produce 32 kg of water daily.
6) Ventilating the “Hydrobattery” to adsorb atmospheric water. As mentioned previously, although the polymer in the “Hydrocells” passively adsorbs humidity from the air through natural ventilation, the process can be accelerated to reach the saturation limit of the plates in a shorter time. This can be achieved using small fans (FIG. 3) measuring 120 mm×120 mm, operating at 12 V, 2400 rpm, consuming around 3 W and having an air displacement speed of 3 m/s. Due to their low consumption, they are suitable for powering by batteries recharged by photovoltaic panels, if the saturation time of the “Hydrocells” through natural ventilation does not support a daily production of 6 to 8 liters with 7 Hydrobatteries, with one being used daily and the other 6 storing water. The entire lateral area of a “Hydrobattery” must be covered by a set of fans; for the dimensions of the “Hydrobattery” in the example, there are a total of 12 fans, allowing an air displacement of 1866 m³/h. The amount of water contained in a “Hydrobattery” can be easily determined by weighing the same. The Hydrobattery can adsorb atmospheric water in a temperature range between 5° C. and 45° C., with relative humidity above 20%. In conditions of relative humidity of 50% to 80% between 20° C. and 35° C., a “Hydrocell” with potassium HPAN reaches the saturation point of 80% of its weight in water in 2 days. Between 20% and 40% relative humidity, under the same temperature conditions, the process can take 7 days. In this case, the use of ventilation, especially at night, can reduce this time to 3 days. Once saturated with water, the “Hydrobatteries” can be taken to the oven to release the water, which then transforms into a gaseous state and then back into a liquid state for harvesting and storage.
7) Placing the “Hydrobattery” in the oven to desorb the water. Inserting the “Hydrobattery” into the oven (FIG. 5 and FIG. 6) is very easy, as they are equipped with wheels that fit onto the oven rails. The oven can be preheated with solar energy from photovoltaic panels. The “Hydrocells” begin to lose water above 50° C. However, for the entire dehydration process of a “Hydrobattery” of 25 “Hydrocells” to last a solar cycle, temperatures between 70° C. and 80° C. can be used. An example of an oven assembled according to this invention can be seen in FIGS. 4 and 5. The resistances are located externally, fixed to the oven wall for optimal thermal utilization, in sufficient quantity to obtain a power of 2000 W. A condensing coil is placed at the bottom of the oven over a condensate water harvesting box, with a drain to the reservoir immediately below (FIG. 6). The coil-shaped condensation system is cooled with closed-loop water flowing from the outlet of a fan-cooled heat exchanger. The temperature of the reservoir's circulating water is kept below 35° C. for an efficient condensation. The oven roof also has a fan to better distribute the air internally.

All the oven components, such as the temperature controller, fans, pumps, and ozonizer, are powered by AC power from a voltage inverter connected to a 500 W photovoltaic panel and a 100 AH battery. The oven's resistances, with a total power of 2000 W, are directly connected to DC voltage from four 580 W solar panels. Using a temperature of 80° C. in the oven described above, water flow rates of up to 2 L/h are obtained during the desorption process, and the process must be completed when the flow rate falls below 0.5 L/h. After dehydration, the “Hydrobattery” can be moved to the ventilation area for recharging, and the following day, another “Hydrobattery”, already saturated with water, can be used for a new daily production. The entire process is very simple and robust; only heating the oven is necessary for water production.
8) Harvesting, filtering, and mineralizing atmospheric water. The water condensed in the coil is stored in a reservoir located below the oven. Because it is obtained by steam condensation, it is highly pure. It is free of inorganic contaminants such as heavy metals and toxic organic substances like pesticides, polyaromatic hydrocarbons, organic solvents, hormones, etc. Microbiologically, it is very pure and does not contain any bacteria or pathogenic microorganisms. However, since the water in the reservoir can be contaminated with microorganisms from the air over time, the water undergoes ozone treatment every hour for 10 minutes. A small electric ozonator with a production capacity of 0.8 g of ozone per hour is used for this purpose. The air-ozone mixture is bubbled into the reservoir, thus maintaining the water sterility. When the water is to be used, a pump is activated, passing the water through an activated carbon filter to remove traces of taste and odor, and, next, the water is passed through a mineralizing filter that adds minerals, primarily calcium and magnesium. The water produced in the atmospheric water generator is extremely pure and fulfills its role in hydration, but before the consumption, it must always be mineralized first, using mineral salts contained within the mineralizing filter. After this treatment process, the water produced by the atmospheric water generator, according to this invention, meets all potability standards for safe consumption, as it is free of all chemical and biological contaminants found in water treated by conventional methods. It can also be used for animal consumption, food preparation, and plant cultivation.
9) Allowing the “Hydrobattery” exposed to air again to repeat the water adsorption cycle, and so on. Once the water stored in the “Hydrobattery” has been exhausted by the thermal desorption process in the oven, it is ready to store a new quantity of water captured from the atmospheric air, in a process that can be passive over several days or more rapid by using ventilation. The process is most easily accomplished by placing the “Hydrobatteries” on ventilation carriages (FIG. 3), with an arrangement of low-consumption fans, such as 3 W 12 V fans measuring 120 mm×120 mm and having an air displacement speed of 3 m/s. For the lateral area of 0.22 m² of the “Hydrobattery” presented in this invention, a total of 12 fans are used in a 4×3 arrangement, resulting in a total consumption of only 36 W, easily supplied by a battery at night, when the atmospheric humidity is higher. The daytime ventilation can be maintained, and during the day, energy can be supplied directly by a photovoltaic panel. The simplest way to get results without consuming any energy is to leave the carriages of the “Hydrobatteries” in a covered location with good natural ventilation. Depending on the ambient humidity conditions above 60%, within 2 or 3 days the “Hydrobattery” is fully charged, reaching 300 g of water per “Hydrocell” and is ready to be sent to the thermal desorption oven again. In this way, this cycle can be repeated for several years, since the polymer present in the “Hydrocell” does not degrade at the desorption temperature used in this invention.

### EXAMPLES OF EMBODIMENT

The present invention will now be described in greater detail by means of examples. The present invention should not be limited to the examples described herein. All polymers used in the examples were synthesized as described in patent BR 10 2020 006578-5 and patent application US20230108608.

Example 1. Polymer prepared by alkaline hydrolysis of the Homopolymeric Polyacrylonitrile, molecular weight of Mw 251.3 kD and Mn 64.6 kD, with potassium hydroxide, with the following characteristics: potassium salt of the cross-linked hydrolyzed polyacrylonitrile, with a moisture content of 6.2%, potassium content of 24.91%, nitrogen content of 10.38%, degree of swelling with distilled water of 470 g/g, degree of swelling with 0.9% NaCl of 55 g/g, soluble fraction content of 1.7%, pH at 25° C. at a concentration of 2 g/L of 8.01, and degree of saturation at relative humidity above 60% in air of 80% (M/M).

Approximately 200 g of this polymer were distributed into 25 rectangular molds measuring 250 mm×310 mm and 10 mm deep. The powder was allowed to agglomerate by atmospheric water adsorption for a period of 24 h in a location with relative humidity between 60% and 80%. After this period, a cellulose screen with the same dimensions as the mold was applied. A new layer of 200 g of salt was then applied to the screen and allowed to absorb humidity from the air for 24 hours, after which it was demolded. Using a stainless steel structure as a frame with the same dimensions as the mold (250 mm×310 mm, 10 mm thick, and a 15 mm rim on each side), a rectangular stainless steel screen measuring 248 mm×308 mm with a 3 mm×3 mm mesh was placed as the bottom. Within this frame with the screen, the polymer plate was placed, which, because it is compressible, fitted perfectly. A new stainless steel screen was applied over the polymer placed in the frame, and on top of the same a rectangular frame measuring 248 mm×308 mm with a 15 mm rim on each side. The frame, stainless steel screens, polymer plate, and rim were secured with stainless steel screws, three on each side.

At the top of the frame, already filled with the polymer plate and secured with the screws, a 3 mm diameter by 300 mm long stainless steel rod was inserted across its entire width, leaving 20 mm on each side protruding from the frame. Thus constructed, this “Hydrocell” can be hung on a rectangular box-shaped structure, the “Hydrobattery.” Each “Hydrocell” produced according to this example, containing 400 g of the polymer, can store 320 g of atmospheric water, has a surface area of 0.103 m², with a water desorption temperature below 100° C., with the ideal temperature being 80° C.

To manufacture a “Hydrobattery” with a surface area of 2.73 m², 25 “Hydrocells” were used, mounted on a structure of stainless steel brackets measuring 305 mm wide×330 mm high×680 mm deep. Grooves are cut every 20 mm at the top of the structure to hang the “Hydrocells” and keep them separated for better air circulation.

Four pulleys are also attached to this same structure, running on rails. A “Hydrobattery” like this can store up to 8.0 kg of water and have its water desorbed in the oven heated to 80° C. by using solar energy from four 580 W photovoltaic panels heating the oven's resistance elements, resulting in a consumption of 1 kWh per 1 L of water with a flow rate of 1.5 L to 2 L per hour. Likewise, it was recharged in 1 week, left in the air with relative humidity between 60% and 80% and under ventilation of 3 m/s for 2 days.

Example 2. Polymer prepared by alkaline hydrolysis of the Homopolymeric Polyacrylonitrile, molecular weight of Mw 251.3 kD and Mn 64.6 kD, with sodium hydroxide, with the following characteristics: sodium salt of the cross-linked hydrolyzed polyacrylonitrile, with moisture content of 6.5%, sodium content of 11.6%, nitrogen content of 10.91%, degree of swelling with distilled water of 490 g/g, degree of swelling with 0.9% NaCl of 61 g/g, soluble fraction content of 1.9%, pH at 25° C. at a concentration of 2 g/L of 7.95, degree of saturation at relative humidity above 60% in air of 74% (M/M).

To prepare the “Hydrocell” and the “Hydrobattery” with this polymer, the procedure described in Example 1 was used.

Each “Hydrocell” produced in this way, containing 400 g of the polymer, can store 296 g of atmospheric water, with a water desorption temperature below 100° C., the ideal temperature being 70° C.

Each “Hydrobattery” produced in this way, containing 25 “Hydrocells,” can store up to 7.4 kg of water and can have its water desorbed in the oven heated to 70° C. using solar energy from four 580 W photovoltaic panels heating the oven's resistance elements, resulting in a consumption of 1.1 kWh per 1 L of water with a flow rate of 1.2 L to 1.8 L per hour. Likewise, it was recharged in 1 week, left in the air with relative humidity between 60% and 80% and under ventilation of 3 m/s for 3 days.

Example 3. Polymer prepared by alkaline hydrolysis of the Polyacrylonitrile copolymerized with 6.0% vinyl acetate, molecular weight of Mw 127.8 kD and Mn 33.6 kD, with potassium hydroxide, with the following characteristics: potassium salt of the cross-linked hydrolyzed poly(acrylonitrile-vinyl co-acetate), with moisture content of 6.5%, potassium content of 23.7%, nitrogen content of 10.11%, degree of swelling with distilled water of 428 g/g, degree of swelling with 0.9% NaCl of 51 g/g, soluble fraction content of 2.5%, pH at 25° C. at a concentration of 2 g/L of 7.77 and degree of saturation at relative humidity above 60% in air of 71% (M/M).

To prepare the “Hydrocell” and the “Hydrobattery” with this polymer, the procedure in Example 1 was used.

Each “Hydrocell” produced in this way, containing 400 g of the polymer, can store 284 g of atmospheric water, with a water desorption temperature below 100° C., the ideal temperature being 77° C.

Each “Hydrobattery” produced in this way, containing 25 “Hydrocells,” can store up to 7.1 kg of water and can have its water desorbed in the oven heated to 77° C. using solar energy from four 580 W photovoltaic panels heating the oven's resistance elements, resulting in a consumption of 1.2 kWh per 1 L of water with a flow rate of 1.6 L to 2.0 L per hour. Likewise, it was recharged in 1 week, left in the air with relative humidity between 60% and 80% and under ventilation of 3 m/s for 2 days.

Example 4. Polymer prepared by alkaline hydrolysis of the Polyacrylonitrile copolymerized with 5.0% methyl acrylate with molecular weight of Mw 99.5 kD and Mn 31.7 kD, with potassium hydroxide, with the following characteristics: potassium salt of the cross-linked hydrolyzed poly(acrylonitrile-methyl co-acrylate), with moisture content of 7.3%, potassium content of 24.1%, nitrogen content of 11.7%, degree of swelling with distilled water of 391 g/g, degree of swelling with 0.9% NaCl of 57 g/g, content of soluble fraction of 2.3%, pH at 25° C. at a concentration of 2 g/L of 7.66 and degree of saturation at relative humidity above 60% in air of 77% (M/M).

To prepare the “Hydrocell” and the “Hydrobattery” with this polymer, the procedure in Example 1 was used.

Each “Hydrocell” produced in this way, containing 400 g of the polymer, can store 308 g of atmospheric water, with a water desorption temperature below 100° C., the ideal temperature being 80° C.

Each “Hydrobattery” produced in this way, containing 25 “Hydrocells,” can store up to 7.7 kg of water and can have its water desorbed in the oven heated to 80° C. using solar energy from four 580 W photovoltaic panels heating the oven's resistance elements, resulting in a consumption of 1.1 kWh per 1 L of water with a flow rate of 1.5 L to 2.0 L per hour. Likewise, it was recharged in 1 week, left in the air with relative humidity between 60% and 80% and under ventilation of 3 m/s for 2 days.

Example 5. Polymer prepared by alkaline hydrolysis of the Polyacrylonitrile copolymerized with 15.0% styrene with a molecular weight of Mw 74.3 kD and Mn 26.8 kD with the following characteristics: moisture content of 8.4%, lithium content of 5.21%, nitrogen content of 7.97%, degree of swelling with distilled water after drying: 294 g/g, degree of swelling with 0.9% NaCl of 43 g/g, soluble fraction content of 2.6%, pH at 25° C. at a concentration of 2 g/L of 7.85 and degree of saturation at relative humidity above 60% in air of 84% (M/M).

To prepare the “Hydrocell” and the “Hydrobattery” with this polymer, the procedure in Example 1 was used.

Each “Hydrocell” produced in this way, containing 400 g of the polymer, can store 336 g of atmospheric water, with a water desorption temperature below 100° C., the ideal temperature being 68° C.

Each “Hydrobattery” produced in this way, containing 25 “Hydrocells,” can store up to 8.4 kg of water and can have its water desorbed in the oven heated to 68° C. using solar energy from four 580 W photovoltaic panels heating the oven's resistance elements, resulting in a consumption of 0.9 kWh per 1 L of water with a flow rate of 1.8 L to 2.1 L per hour. Likewise, it was recharged in 1 week, left in the air with relative humidity between 60% and 80% and under ventilation of 3 m/s for 2 days.

Although the invention has been described in conjunction with its specific embodiments, it is evident that many alternatives, modifications, and variations will be apparent to those skilled in the art in light of the foregoing description. Thus, the present invention encompasses all such alternatives, modifications, and variations within the spirit and scope of the attached claims.

Those skilled in the art will value the knowledge presented herein and will be able to reproduce the invention in the presented embodiments and in other variations encompassed by the scope of the appended claims.

1. A process for preparing and using Hydrocells for producing atmospheric water, using superabsorbent polymers, comprising the following steps:
1) manufacturing a Hydrocell using a superabsorbent polymer;
2) arranging the Hydrocell to produce a Hydrobattery module;
3) carrying out a water absorption cycle by allowing the Hydrobattery to adsorb atmospheric water;
4) carrying out a water desorption cycle by placing the Hydrobattery in an oven to desorb the water;
5) harvesting, filtering, and mineralizing the obtained atmospheric water; and
6) carrying out another water absorption cycle by allowing the Hydrobattery to be exposed to air and repeating steps 3) through 5).

2. The process according to claim 1, wherein in step (1) the superabsorbent polymer comprises polyacrylonitrile or its copolymers.

3. The process according to claim 1, wherein in step (1) the superabsorbent polymer comprises sodium, potassium, and lithium salts of a hydrolyzed polyacrylonitrile.

4. The process according to claim 1, wherein in step (1) the superabsorbent polymer comprises alkaline salts of hydrolyzed polyacrylonitrile and copolymers thereof and have a cross-linked polymer chain, have a swelling degree of 150 g to 800 g of water per gram of the polymer, and have an adsorption capacity of atmospheric water up to 85% of their weight.

5. The process according to claim 1, wherein in step (2) plates comprising the polymer are used in the production of the Hydrocell, wherein the plates are obtained by applying salts of cross-linked hydrolyzed polyacrylonitrile in powder form, inside molds.

6. The process according to claim 1, wherein in step (2) plates comprising the polymer are used in the production of the Hydrocell, wherein the plates are obtained after exposing a powder to humid air, wherein the powder has been previously placed inside a mold.

7. The process according to claim 1, wherein in step (2) plates comprising the polymer are molded and placed inside a metal or plastic structure and screens, providing mechanical rigidity and a large surface area, thereby forming the Hydrocell.

8. The process according to claim 1, wherein in step (3) the Hydrocell is placed on a clothesline-shaped structure containing several units, in an arrangement with a surface area greater than 1 m².

9. The process according to claim 1, wherein in step (4) the Hydrobattery is exposed to humid air to perform water adsorption.

10. The process according to claim 1, wherein in step (5) the Hydrobattery, after adsorbing a desired amount of water, is placed in a heated oven for water desorption.

11. The process according to claim 1, wherein in step (6) after the desorption, the water is released from the Hydrobattery in the form of vapor and can be condensed, stored, and treated for use.

12. The process according to claim 1, wherein the Hydrobattery, after undergoing water desorption, is used again for a large number of adsorption and desorption cycles.

13. The process according to claim 5, wherein the Hydrocell is rectangular or circular in shape, has screens in an area exposed to the air, and a flexible fabric in a middle area to provide better mechanical strength.

14. The process according to claim 5, wherein the Hydrocell is capable of desorbing water at a temperature lower than its boiling point or 100° C.

15. The process according to claim 8, wherein the Hydrobattery is placed in a ventilated location, with good air exchange to passively adsorb humidity or be subjected to forced ventilation until reaching saturation.

16. The process according to claim 8, wherein the Hydrobattery adsorbs atmospheric water in a temperature range between 5° C. and 45° C., with relative humidity above 20%.

17. The process according to claim 10, wherein the heating of the Hydrobattery for water desorption is carried out using solar energy in the form of photovoltaic, solar thermal, or in the absence of these, only alternating energy from the electrical grid or hybrid energy.

18. The process according to claim 10, wherein the heating of the Hydrobattery for water desorption consumes between 0.6 and 2 kWh.

19. The process according to claim 10, wherein the heated oven used to heat the Hydrobattery comprises an internal fan for air circulation, a water condenser, a water harvesting tank, electrical resistances in the walls, thermal insulation, a door with a hinge and latch, a temperature controller, and rails for placing and removing the Hydrobattery.

20. The process according to claim 11, wherein the water desorbed by the Hydrobattery is stored in a reservoir, treated with ozone or ultraviolet light, and passed through an activated carbon filter and a mineralizing filter, before consumption.
